(19) United States
(12) Patent Application Publication
(10) Pub. No.: US 2011/0153978 A1
(43) Pub. Date: Jun. 23, 2011

(54) Predictive Page Allocation for Virtual Memory System

(75) Inventors: Glen Edmond Chalemin, Austin, TX (US); Sreenivas Makineedi, Austin, TX (US); Vandana Mallempati, Austin, TX (US)

(73) Assignee: International Business Machines Corporation, Armonk, NY (US)

(21) Appl. No.: 12/643,784

(22) Filed: Dec. 21, 2009

(51) Int. Cl. G06F 12/02; G06F 12/00; G06F 12/10

(52) U.S. Cl. 711/171; 711/170; 711/206; 711/E12.001; 711/E12.002; 711/E12.059

(57) ABSTRACT

A virtual memory method for allocating physical memory space required by an application by tracking the page space used in each of a sequence of invocations by an application requesting memory space; keeping count of the number of said invocations; and determining the average page space used for each of said invocations from the count and previous average. Then, this average page space is recorded as a predicted allocation for the next invocation. This recorded average space is used for the next invocation. If there is any additional page space required by said next invocation, this additional page space may be accessed through any conventional default page space allocation.

### TECHNICAL FIELD

The present invention is directed to memory used to implement virtual memory, and particularly to predictive allocation of the memory space required by computer applications running on a computer which may require iterative allocations of memory space.

### BACKGROUND OF RELATED ART

Virtual memory is an abstract concept of memory which a computer system uses when it references memory. Virtual memory consists of the computer system's main memory (RAM), its file systems, and paging space. At different points in time, a virtual memory address referenced by an application may be in any of these locations. The application does not need to know which location, as the computer system's virtual memory manager (MM) will transparently move blocks of data around as needed. These blocks of data are of fixed size, typically 4K or 64K. While the sizes of these pages in the file system and in paging space remain constant, there is a VMM mechanism in place to convert pages in RAM from one size to the other as a demand for a size increases.

Virtual memory is extension of the computer system's main memory (RAM) or shared memories such as shared memory libraries via a virtual address space. The virtual address space which may include the computer's disk drive, and other mass storage facilities. In such virtual memory systems, virtual memory addresses of blocks of data in the form of Pages are translated into addresses of pages into allocated i.e. mad available in the much smaller physical memories under the control of virtual memory manager. This translation involves a conversion of the blocks or memory pages from a secondary source, e.g. disk drive, to the primary memory, e.g. RAM, whenever the execution of a running application program requires the pages that are transferred in a sequence of invocations from paging space. It is a goal of virtual memory management to permit several running application programs to run seamlessly with respect to the operating system so that a relatively large virtual address range may run on a relatively small amount of physical memory with little reduction in computer speed. Representative paged memory systems are described in U.S. Pat. No. 5,706,461 and in the IBM Journal of Research and Development article: Multiple Page Sizing and Modeling and Optimization, Vol 50, pp. 238-248, March 1960.

In order to achieve smooth and seamless effects when running one or more application programs, methods (algorithms) for allocating page space (pages), virtual memory systems strive for fast and effective allocations in response to each sequential invocation by the application for paging space pages to physical memory pages. Over the years, many schemes have been tried and used for such allocations. These include:

Early paging space allocation (e.g. represented by the Environment Variable, PSALLOC-early); this sets aside all requested (malloc'd) page space, irrespective of how much memory space is actually used in virtual memory. This could potentially dissipate a lot of space, which, in turn, could lead to a page-space low scenario.

Deferred paging space allocation (e.g. represented by the Environment Variable, PSALLOC=deferred); this waits to assign paging space until a page is going to be paged out of RAM and may risk the situation wherein page space is not available when actually needed.

Late paging space allocation (e.g. represented by the Environment Variable, SALLOC=late); this waits to assign page space until a page is touched and also may risk the situation wherein page space is not available when actually needed.

In view of this background, it is desirable to seek an algorithm that would predict the amount of memory required for a subsequent allocation in response to a subsequent invocation by a running application program.

### SUMMARY OF THE INVENTION

The present invention improves upon the prior art situation in the allocation of paging space through a predictive allocation (e.g. represented by the Environment Variable, PSALLOC-predictive) that provides for the prediction of the amount of paging space that is predicted to actually be used. The algorithm for this predictive allocation is continuously heuristically updated based upon the paging space actually used for an invoked sequential allocation that has been predicted.

In its broadest aspects, the present invention provides a virtual memory method for allocating page space required by an application that comprises tracking the page space used in each of a sequence of invocations by an application requesting memory space, keeping count of the number of said invocations and determining the average paging space used for each of the invocations from the count and total paging space used. Then, this average paging space is reserved as a predicted allocation for the next invocation. This reserved paging space is used for the next invocation. If there is any additional paging space required by said next invocation, this paging space may be accessed through any conventional default memory space allocation. Finally, whether or not additional default memory is needed, the actual paging space used in the next invocation is tracked and used to update the average paging space used. The method of the present is applicable in systems wherein a single application program or multiple application programs are running and each requires a sequence of invocations for pacing space. The described predictive page allocation is also applicable wherein the application uses space in shared libraries.

The primary aspect of the present invention is in the predicted allocations of space in computer memory. In a further aspect of the present invention, in a paged virtual memory in which the physical memory space is divided into pages of different sizes, a conventional threshold may be predetermined wherein the RAM to be used by said application will require a conversion of pages of one different size to another. Then, when this determined average memory space reaches the threshold, the conversion of the pages in said reserved RAM may be commenced. This conversion is particularly advantageous when the threshold requires a promotion, i.e. a conversion from smaller to larger pages.

The method described for predetermining a threshold, wherein the RAM to be used by the application will require a conversion of pages of one different size to another is likewise applicable where the application uses space in shared libraries.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a generalized data processing system including the virtual memory management that may be implemented to predict allocation of physical memory and to commence page size conversion;

FIG. 2 is a general flowchart of a program set up to implement the present invention for predicting and reserving paging space for subsequent invocations for space from running application programs;

FIG. 3 is a general flowchart of a program set up to implement the present invention aspect in which the predicted allocated paging space for subsequent invocations defines whether a predetermined threshold for page size conversion has been reached;

FIG. 4 is a flowchart of an illustrative run of the program set up in FIG. 2; and

FIG. 5 is a flowchart of an illustrative run of the program set up in FIG. 3.

### DETAILED DESCRIPTION OF THE PREFERRED EMBODIMENT

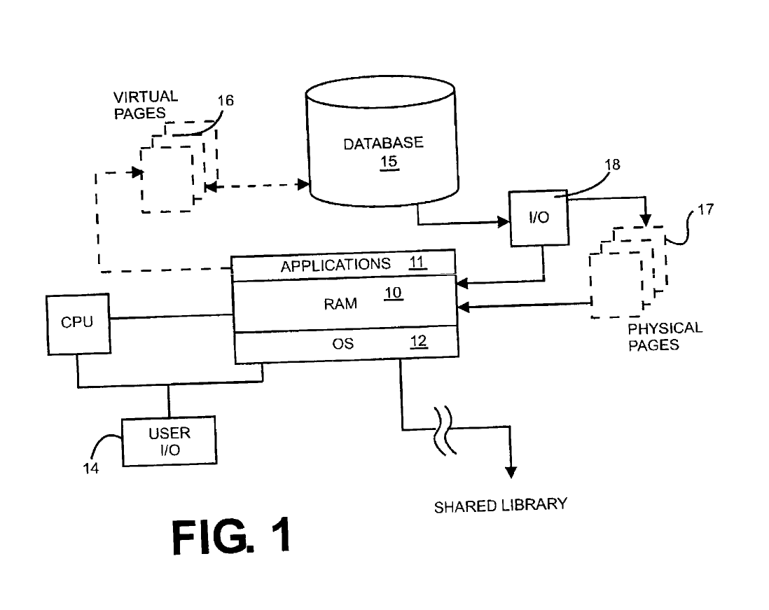

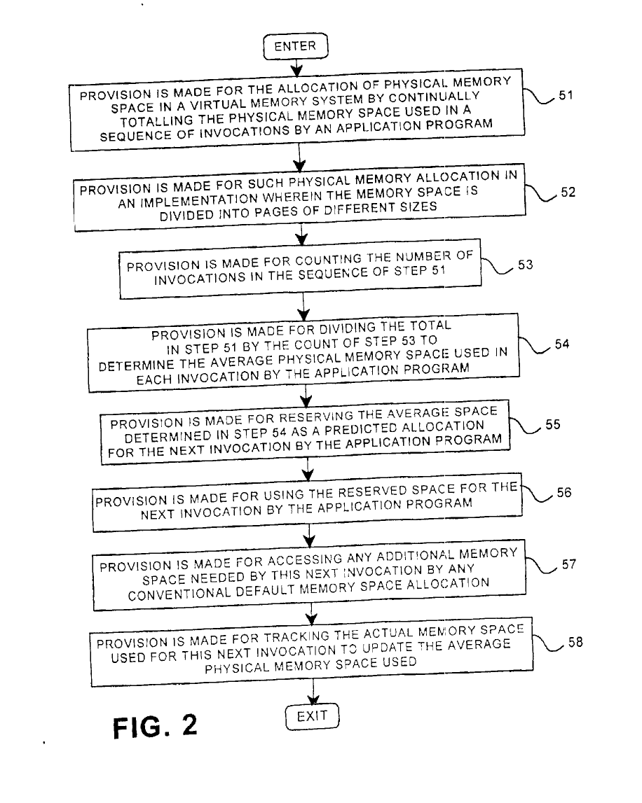

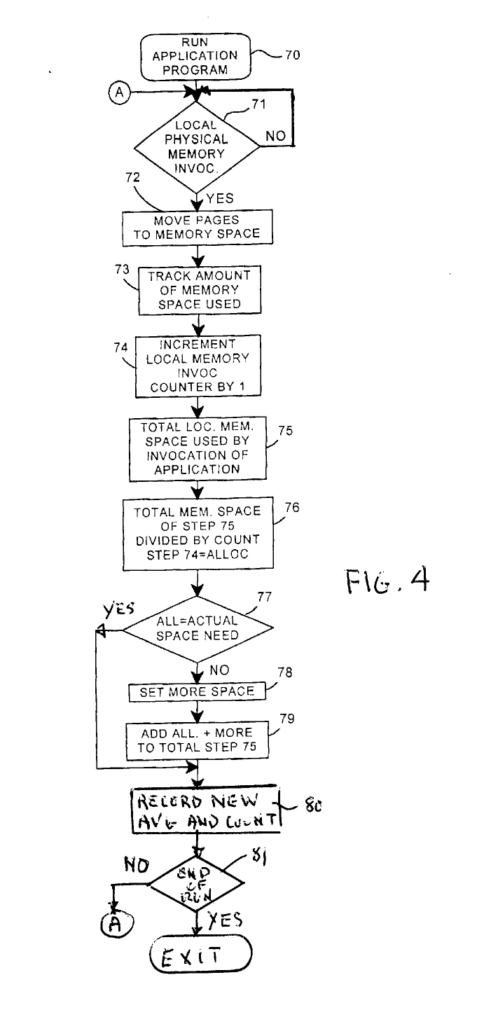

Referring to FIG. 1, there is shown a generalized diagrammatic view of data processing system having a virtual memory system in which the virtual memory management may be implemented to predict allocation of physical memory and to commence page size conversion. The local physical memory of the system is implemented in RAM 10, which includes the applications 11 that are running and making sequential invocations for more conversion or movement of virtual memory pages into physical memory pages. The system is driven/controlled by CPU 13 responsive to user input/output 14. The local or main virtual memory operates within an extended virtual address space that includes RAM 10 and representative database 15 that may include the computer's disk drive. As a running application 11 proceeds with its invocations requiring allocation of paging space, addressed virtual pages 16 via I/O 18 to database 15 are allocated, in accordance with the predicted allocations to be subsequently described with respect to FIGS. 2 and 4, as physical pages 17 of memory to RAM 10 in response to requested virtual pages 16. An application 11 may also use physical space allocated in shared libraries as indicated.

In the predicted allocation algorithm of the present invention, the paging space pages arc reserved for the invocation from the requesting application program. The examples for memory allocations described with respect to FIGS. 2 through 5 will be described for a method wherein the physical memory pages in the form of paging space pages allocated from the local virtual memory will be in RAM 10.

FIG. 2 is a flowchart showing the development of a process according to the present invention for predictive allocation to reserve physical memory space in the form of paging space pages for a next subsequent invocation from virtual memory by an application program running on a data processing system. The physical memory space, i.e. paging space, used by a sequence of invocations from virtual memory by an application program is continually totaled, step 51. Provision is made for this physical memory allocation in a system wherein the physical memory allocation is in pages of different sizes, step 52. Provision is made, step 53, for the counting of the number of invocations in the sequence of step 51. Provision is made for dividing the total physical memory space used in step 51 by the count of step 53 to determine the average paging space used in each invocation of the application program, step 54. Provision is made for recording this average as determined in step 54 as a predicted allocation for the next invocation by the application program, step 55. Provision is made for using the reserved space for the next invocation by the application program, step 56. Provision is made for accessing any additional memory space needed by this next invocation by any conventional default memory space allocation, step 57. Provision is made for the tracking of the actual memory space used for this next invocation to update the average physical memory space used, step 58.

The following is an example of a simplified set of program instructions of the process of FIG. 2. Assume that a running application program is invoking virtual to physical memory allocations both at the RAM of the local data processing system and at the RAM of a connected shared library. In the instructions are the following set of values:
cnt=the number of invocations
data bytes=the average number of data bytes (stack+heap) in local memory used by the appln.
shlib bytes=the average number of bytes in shared library used by appln.

The updating of the averages may be illustrated as follows:

Assume the following values: cnt=3, data bytes−100, and shlib bytes=50.

A next invocation uses 500 bytes in local memory and 70 bytes in the shared library.

Thus, before this next invocation cnt*databytes=300; the next invocation adds 500 bytes. Then total=80C divided by a cnt=4. New average data bytes=200.

Before this next invocation cnt*databytes=150; the next invocation 70 bytes. Then total=220 divided by a cnt=4. New average shlib bytes=55.

Store the new averages: data bytes=200, shlib bytes=55 and increment counter to cnt=4.

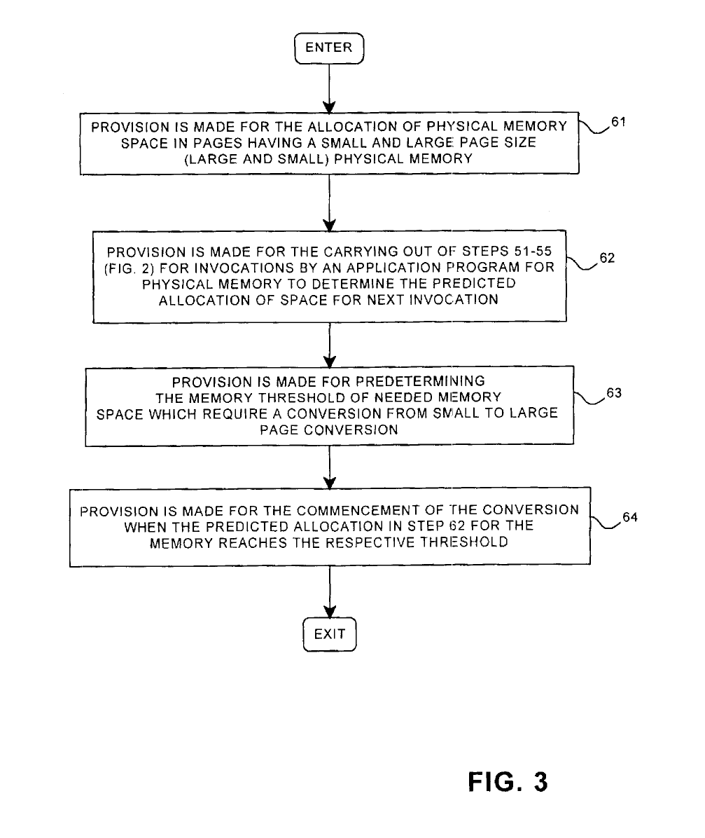

FIG. 3 is a general flowchart of a program set up to implement the present invention aspect in which the predicted allocated physical memory space for subsequent invocations defines whether the a predetermined threshold for pace size conversion has been reached. Provision is mace for the allocation of physical memory space in pages having a small and large page size in physical memory, step 61. Provision is made for carrying out steps 51-55, (FIG. 2) for invocations by an application program for the memory to determine the predicted allocation of space for the next invocation of each, step 62. Provision is made for predetermining a threshold of needed memory space that would require a conversion from small to large page, step 63. This is particularly needed when the large pages are 64K bytes and the small pages are 4K bytes in size. Provision is made for the commencement of the conversion when the predicted allocation in step 62 reaches the respective threshold, step 64.

A flowchart of an illustrative run of the program set up in FIG. 2 for predicting and reserving physical memory space for subsequent invocations for space from running application programs, will now be described with respect to FIG. 4. An application program is running, step 70. A determination is made as to whether there is a memory invocation, step 71. If Yes, the invoked pages are moved to physical memory, step 72. The amount of memory space used in memory for step 72 is tracked, step 73. The counter for memory invocations is incremented by one, step 74. The memory space used by the invocations of the application program is totaled, step 75. This total used memory space of step 75 is divided by the count in the counter to calculate the average space that equals the predicted allocated space (Alloc), step 76. Then a determination is made as to whether Alloc at least equals the memory actually needed for invoked physical memory pages, step 77. If No, additional physical memory space is accessed, step 78, and step 79, the allocated space, plus the additional space, are added to the total memory space used in step 75. Then, or if the determination in step 77 is Yes, no more memory space is needed, the new average is recorded and a new count is made by the counter, step 80. Then at step 81 a decision is made as to whether the run of the application program is ended. If Yes, the run is exited. If No, the process is returned via branch “A” to step 71.

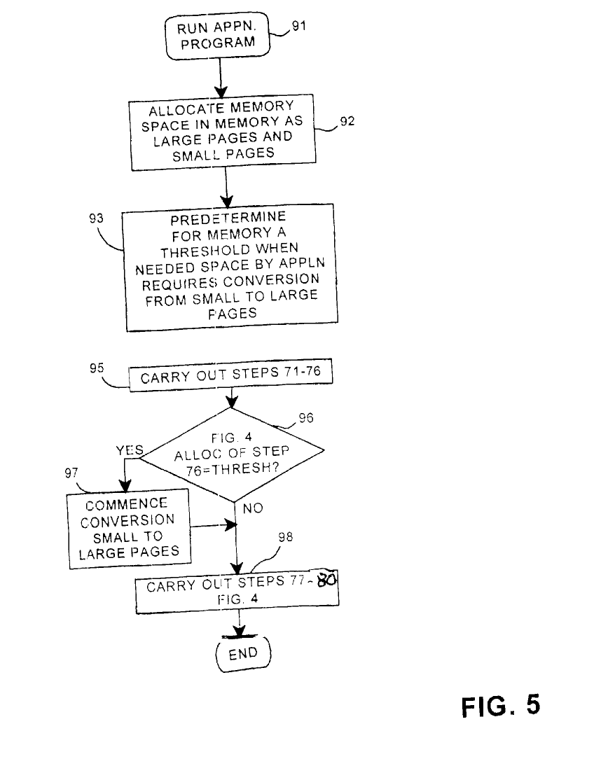

Now with respect to FIG. 5 there will be described an illustrative run of the program of FIG. 3 set up to implement the present invention aspect in which the predicted allocated physical memory space for subsequent invocations defines whether the a predetermined threshold for page size conversion has been reached. In the running of an application program, step 91, memory space in the form. of pages is allocated in memory in large and small physical memory pages, step 92. The present process is particularly useful when the page sizes are 64K bytes for large and 4K bytes fur small. There is predetermined for the memory a threshold for which the space needed by the running application requires conversion from small to large pages, step 93. The application program is now run by carrying out steps II through 76 of the process described in FIG. 4, step 95. A determination is made, step 96, as to whether the Alloc of step 76, FIG. 4, has reached a threshold. if Yes, conversion from small to large pages is commenced, step 97. Then, or if the decision from step 96 is No, steps 77 through 80 of the process described in FIG. 4 are carried out, step 98.

Although certain preferred embodiments have been shown and described, it will be understood that many changes and modifications may be made therein without departing from the scope and intent of the appended claims.

What is claimed is:

1. A virtual memory method for allocating page space required by an application comprising:
tracking the page space used in each of a sequence of invocations by said application requesting memory space;
counting the number of said invocations;
determining the average page space used for each of said invocations from said count and total space used by said number of said invocations;
reserving said average page space as a predicted allocation for the next invocation;
using said reserved memory space for said next invocation;
accessing any additional page space required by said next invocation through a default memory space allocation; and
tracking the page space used in said next invocation to update said average page space used.

2. The method of claim 1 wherein said page space is used by a plurality of applications.

3. The method of claim 1 wherein:
said application is stored in computer RAM divided into pages of different sizes; and further including:
predetermining a threshold wherein the RAM to be used by said application will require a conversion of pages of one different size to another; and
commencing said conversion of the pages in said RAM when said determined average memory space reaches said threshold.

4. The method of claim 3 wherein said conversion of pages includes a promotion.

5. The method of claim 3 wherein said conversion of pages includes a demotion.

6. The method of claim 4 wherein said promotion is a conversion from a 4K page size to a 64K page size.

7. A virtual memory system for allocating page space required by an application, the system comprising:
a processor;
a computer memory holding computer program instructions that, when executed by the processor, perform the method comprising:
tracking the page space used in each of a sequence of invocations by said application requesting memory space;
counting the number of said invocations;
determining the average page space used for each of said invocations from said count and total space used by said number of said Invocations;
reserving said average page space as a predicted allocation for the next invocation;
using said reserved page space for said next invocation;
accessing any additional page space required by said next invocation through a default Page space allocation; and
tracking the page space used in said next invocation to update said average page space used.

8. The system of claim 7 wherein said page space is used by a plurality of applications.

9. The system of claim 7 wherein:
said application is stored in computer RAM divided into pages of different sizes; and
said performed method further includes:
predetermining a threshold wherein the RAM to be used by said application will. require a conversion of pages of one different size to another; and
commencing said conversion of the pages in said RAM when said determined average memory space reaches said threshold.

10. The system of claim 9 wherein said conversion of pages includes a promotion.

11. The system of claim 9 wherein said conversion of pages includes a demotion.

12. The system of claim 10 wherein said promotion is a conversion from a 4K page size to a 64K page size.

13. A computer usable storage medium having stored thereon a computer readable program for allocating page space required by an application, wherein the computer readable program, when executed on a computer, causes the computer to:
track the page space used in each of a sequence of invocations by said application requesting memory space;
count the number of said invocations;
determine the average page space used for each of said invocations from said count and total space used by said number of said invocations;
reserve said average page space as a predicted allocation for the next invocation;
use said reserved memory page space for said next invocation;
access any additional page space required by said next invocation through a default memory space allocation; and
track the page space used in said next invocation to update said average page space used.

14. The computer usable storage medium of claim 14 wherein said page space is used by a plurality of applications.

15. The computer usable storage medium of claim 13 wherein:
said application is stored in computer RAM divided into pages of different sizes; and
the computer program when executed further causes the computer to:
predetermine a threshold wherein the RAM to be used by said application will require a conversion of pages of one different size to another; and
commence said conversion of the pages in said RAM when said determined average memory space reaches said threshold.

16. The computer usable storage medium of claim 15 wherein said conversion of pages includes a promotion.

17. The computer usable storage medium of claim 15 wherein said conversion of pages includes a demotion.

18. The computer usable storage medium of claim 16 wherein said promotion is a conversion from a 4K page size to a 64K page size.
